(19) United States
(12) Patent Application Publication
(10) Pub. No.: US 2016/0085046 A1
(43) Pub. Date: Mar. 24, 2016

(54) LENS MODULE

(71) Applicant: Samsung Electro-Mechanics Co., Ltd., Suwon-Si (KR)

(72) Inventor: In Gun KIM, Suwon-Si (KR)

(73) Assignee: Samsung Electro-Mechanics Co., Ltd., Suwon-Si (KR)

(21) Appl. No.: 14/641,128

(22) Filed: Mar. 6, 2015

(30) Foreign Application Priority Data
Sep. 22, 2014 (KR) 10-2014-0126163

(51) Int. Cl. G02B 7/02

(52) U.S. Cl. CPC G02B 7/026; G02B 7/021

(57) ABSTRACT

A lens module includes a protrusion portion or an accommodating portion formed in a lens barrel to allow a press-fitting ring supporting lenses to be inserted into the protrusion portion or the accommodating portion, whereby the press-fitting ring may be stably fixed to the lens barrel. Since a process of separately applying and hardening an adhesive in order to fix the press-fitting ring may be omitted, an amount of manufacturing processes and a manufacturing cost of the lens module may be decreased.

### CROSS-REFERENCE TO RELATED APPLICATION

This application claims the priority and benefit of Korean Patent Application No. 10-2014-0126163 filed on Sep. 22, 2014, with the Korean Intellectual Property Office, the disclosure of which is incorporated herein by reference.

### BACKGROUND

The present disclosure relates to a lens module.

A lens barrel accommodating lenses therein is provided in a camera module. Lenses are inserted into and fixed to the lens barrel. In this case, a press-fitting ring is used in order to fix the lenses.

The press-fitting ring is inserted into the lens barrel to contact and support the lenses. Here, the press-fitting ring is fixed to the lens barrel, such that the lenses supported by the press-fitting ring are also fixed to the lens barrel.

Generally, an adhesive is used in order to fix the press-fitting ring to the lens barrel.

Here, in the case in which the press-fitting ring has an outer diameter smaller than an inner diameter of the lens barrel, the adhesive may be introduced into an empty space to have an influence on a position in which the lens is fixed, or the adhesive flows onto an optical surface of the lens to have a negative influence on resolving power.

Therefore, the press-fitting ring is forcibly inserted into an inner portion of the lens barrel in a press-fitting scheme, and is attached to the inner portion of the lens barrel while being bent in an assembly process.

When the assembly of the press-fitting ring is completed, a process of applying and hardening the adhesive in order to fix the press-fitting ring to the lens barrel is performed. However, there is a risk that a position at which the press-fitting ring is fixed will be changed due to elastic force of the press-fitting ring in the process of applying and hardening the adhesive.

Therefore, a structure for more stably fixing the press-fitting ring to the lens barrel has been required.

### SUMMARY

An aspect of the present disclosure may provide a lens module in which a press-fitting ring supporting a lens may be stably fixed to a lens barrel.

An aspect of the present disclosure may also provide a lens module allowing for a reduced manufactured cost and amount of manufacturing processes.

According to an aspect of the present disclosure, a lens module may include a protrusion portion or an accommodating portion formed in a lens barrel to allow a press-fitting ring supporting lenses to be inserted into the protrusion portion or the accommodating portion, whereby the press-fitting ring may be stably fixed to the lens barrel. In addition, since a process of separately applying and hardening an adhesive in order to fix the press-fitting ring may be omitted, an amount of manufacturing processes and manufacturing costs of the lens module may be decreased.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a cross-sectional view of a lens module according to an exemplary embodiment of the present disclosure;

FIG. 2 is a rear view of a lens barrel provided in the lens module according to an exemplary embodiment of the present disclosure;

FIG. 3 is a cross-sectional view of the lens barrel provided in the lens module according to an exemplary embodiment of the present disclosure;

FIG. 4 is an enlarged cross-sectional view of part A of FIG. 1;

FIG. 5 is a cross-sectional view of a lens module according to another exemplary embodiment of the present disclosure;

FIG. 6 is a cross-sectional view of the lens barrel provided in the lens module according to another exemplary embodiment of the present disclosure;

FIG. 7 is an enlarged cross-sectional view of part B of FIG. 5;

FIG. 8 is an enlarged cross-sectional view showing a modified example of part B of FIG. 5; and

FIG. 9 is a partially cut-away perspective view of a press-fitting ring provided in the lens module according to another exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Terms with respect to directions will be defined. An optical axis direction refers to a vertical direction based on a lens barrel 10.

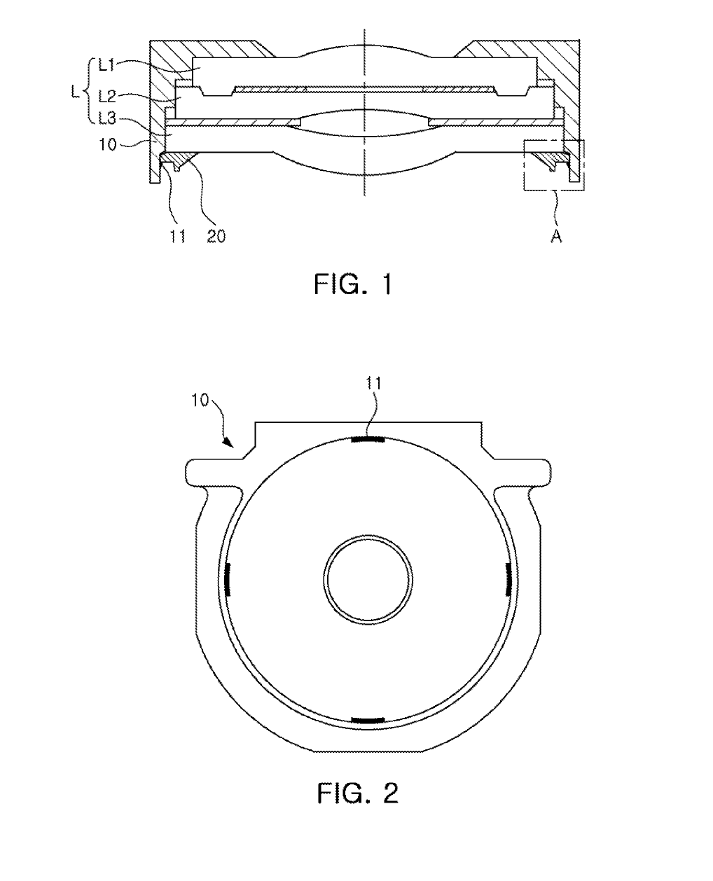

FIG. 1 is a cross-sectional view of a lens module according to an exemplary embodiment of the present disclosure; and FIG. 2 is a rear view of a lens barrel provided in the lens module according to an exemplary embodiment of the present disclosure.

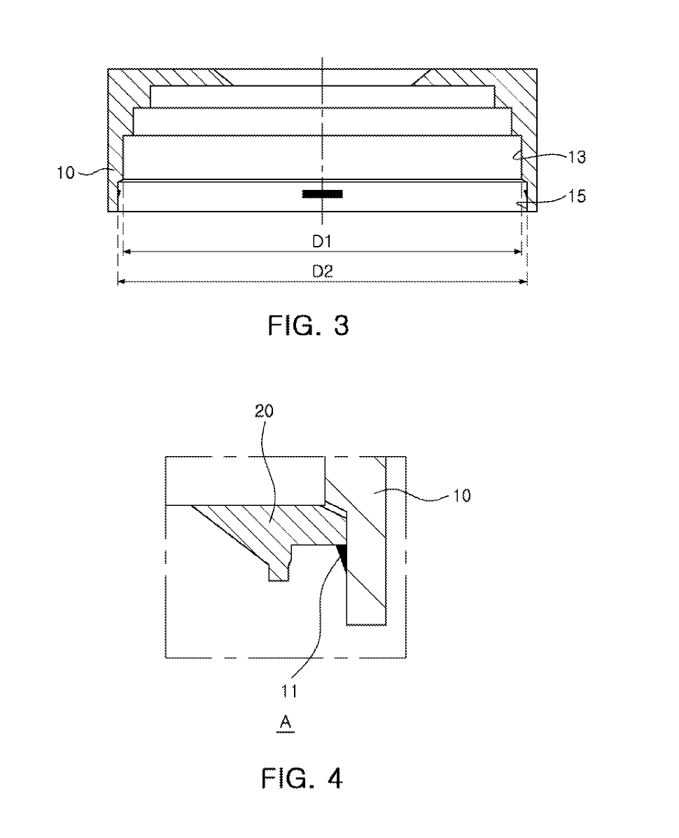

In addition, FIG. 3 is a cross-sectional view of the lens barrel provided in the lens module according to an exemplary embodiment of the present disclosure; and FIG. 4 is an enlarged cross-sectional view of part A of FIG. 1.

Referring to FIGS. 1 through 4, a lens module according to an exemplary embodiment of the present disclosure may include one or more lenses L, a lens barrel 10, and a press-fitting ring 20.

The lens barrel 10 may have a hollow cylindrical shape so that the one or more lenses L photographing a subject may be accommodated therein, and the one or more lenses L may be provided in the lens barrel 10 along an optical axis.

The one or more lenses L may be stacked by a required number depending on a design of the lens module and have optical characteristics such as the same refractive index, or different refractive indices, or the like.

In the case of the number of lenses L is plural, gap maintaining members maintaining gaps between the lenses may be provided between the plurality of lenses.

In the present exemplary embodiment, the one or more lenses L may include a first lens L1, a second lens L2, and a third lens L3.

Although the case in which the lens module includes three lenses has been shown in FIG. 1, the lens module may include three or less lenses or three or more lenses depending on resolution to be implemented.

The first to third lenses L1 to L3 may be formed of a glass, a glass molding material, a thermosetting resin, a thermoplastic resin, or a plastic material.

The first to third lenses L1 to L3 may generally a have positive refractive power or a negative refractive power. More specifically, the first to third lenses L1 to L3 may have different refractive powers, respectively.

The first lens L1 may be disposed in the lens barrel 10 to be closest to a subject. For example, the first lens L1 may be closest to an object side.

The first to third lenses L1 to L3 may be sequentially stacked.

For example, the second lens L2 may be disposed below the first lens L1 in the optical axis direction, and the third lens L3 may be disposed below the second lens L2 in the optical axis direction. Therefore, the third lens L3 may be disposed to be closest to an image side.

Meanwhile, the press-fitting ring 20 may be disposed in the lens barrel 10.

The press-fitting ring 20 may serve to fix the first to third lenses L1 to L3 to an inner portion of the lens barrel 10.

For example, the press-fitting ring 20 may be disposed below the third lens L3 in the optical axis direction to contact and support the third lens L3.

After the first to third lenses L1 to L3 are sequentially inserted into the lens barrel 10, the press-fitting ring 20 may be inserted into the lens barrel 10 to support the third lens L3, thereby fixing the first to third lenses L1 to L3 to the inner portion of the lens barrel 10.

Therefore, the first to third lenses L1 to L3 may be fixed to the inner portion of the lens barrel 10 by the press-fitting ring 20.

Here, since the press-fitting ring 20 is inserted into the lens barrel 10, the press-fitting ring 20 also needs to be fixed to the inner portion of the lens barrel 10 so that the first to third lenses L1 to L3 are fixed by the press-fitting ring 20.

Therefore, in the lens module according to an exemplary embodiment of the present disclosure, a protrusion portion 11 may be provided on an inner surface of the lens barrel 10 to support the press-fitting ring 20.

The protrusion portion 11 may protrude from the inner surface of the lens barrel 10 and have an inclined surface.

For example, the protrusion portion 11 may be formed to have a form inclined toward the center of the lens barrel 10 in a direction from the image side toward the object side.

Here, the press-fitting ring 20 may have an outer diameter corresponding to an inner diameter of the lens barrel 10.

Therefore, when the press-fitting ring 20 is inserted into the lens barrel 10 in a direction from the image side toward the object side, the press-fitting ring 20 may be supported by the protrusion portion 11.

For example, the press-fitting ring 20 may be caught by the protrusion portion 11 while being inserted into the lens barrel 10. Therefore, a lower surface of the press-fitting ring 20 may be contacted and supported by the protrusion portion 11.

Therefore, the press-fitting ring 20 may be fixed to the inner portion of the lens barrel 10.

As shown in FIG. 2, the protrusion portion 11 may include a plurality of protrusions disposed to be spaced apart from each other, and the lower surface of the press-fitting ring 20 may be supported by the plurality of protrusions.

In the case of using an adhesive in order to fix the press-fitting ring 20 to the lens barrel 10, there is a risk that a position at which the press-fitting ring 20 is fixed will be changed due to elastic force of the press-fitting ring 20 in a process of applying and hardening the adhesive.

In the case in which the position at which the press-fitting ring 20 is fixed is changed, there is a risk that the one or more lenses L will not be completely fixed within the lens barrel 10, and there is a risk that optical axes of the one or more lenses L will be misaligned with each other due to the change in the position of the press-fitting ring.

However, in the lens module according to an exemplary embodiment of the present disclosure, since the press-fitting ring 20 is fixedly supported by the protrusion portion 11 provided on the inner surface of the lens barrel 10, the press-fitting ring 20 may be stably fixed to the lens barrel 10 without separately using the adhesive.

In addition, in the case of using the adhesive in order to fix the press-fitting ring 20 to the lens barrel 10, the process of applying and hardening the adhesive needs to be performed.

However, in the lens module according to an exemplary embodiment of the present disclosure, since the press-fitting ring 20 may be fixed to the lens barrel 10 without using the adhesive, the number of manufacturing processes and a manufacturing cost of the lens module may be decreased, and production efficiency of the lens module may be improved.

Meanwhile, the first to third lenses L1 to L3 may be assembled within the lens barrel 10 in the direction from the image side toward the object side. In this case, the first to third lenses L1 to L3 and the protrusion portion 11 interfere with each other in a process of assembling the first to third lenses L1 to L3, such that there is a risk that a crack will occur in the first to third lenses L1 to L3.

In the case in which the crack occurs in the first to third lenses L1 to L3, it has a negative influence on resolving power of the lens module. Therefore, a structure for preventing damage to the first to third lenses L1 to L3 is required.

Therefore, the lens barrel 10 provided in the lens module according to an exemplary embodiment of the present disclosure may include a small diameter portion 13 accommodating the one or more lenses L therein and a large diameter portion 15 accommodating the press-fitting ring 20 therein.

The small diameter portion 13 is formed to have a diameter D1 smaller than a diameter D2 of the large diameter portion 15 and the protrusion portion 11 is formed on the large diameter portion 15, whereby the interference between the first to third lenses L1 to L3 and the protrusion portion 11 in the process of assembling the first to third lenses L1 to L3 may be prevented.

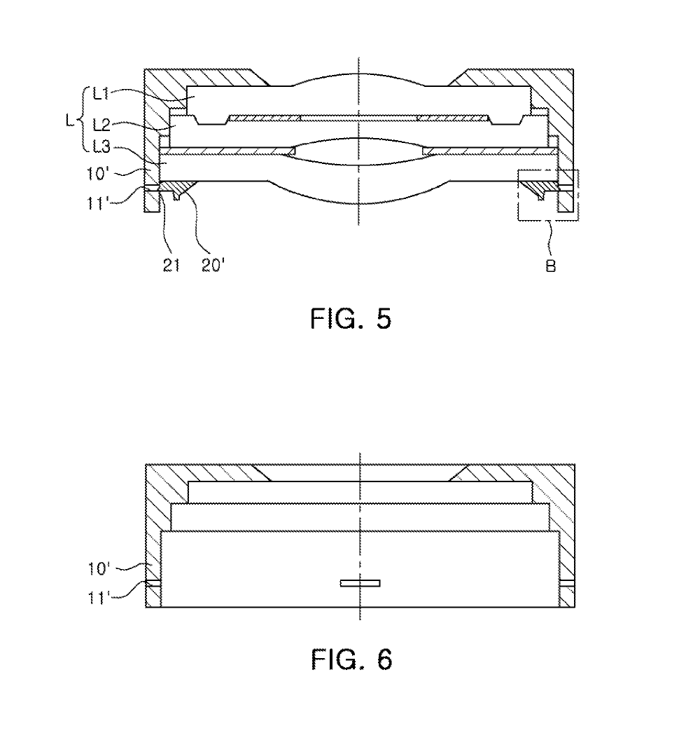

FIG. 5 is a cross-sectional view of a lens module according to another exemplary embodiment of the present disclosure; and FIG. 6 is a cross-sectional view of the lens barrel provided in the lens module according to another exemplary embodiment of the present disclosure.

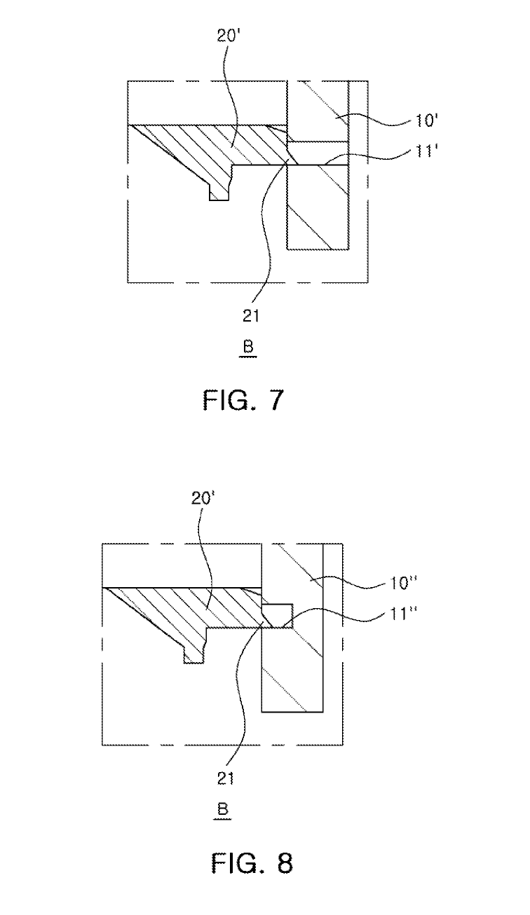

In addition, FIG. 7 is an enlarged cross-sectional view of part B of FIG. 5; and FIG. 8 is an enlarged cross-sectional view showing a modified example of part B of FIG. 5.

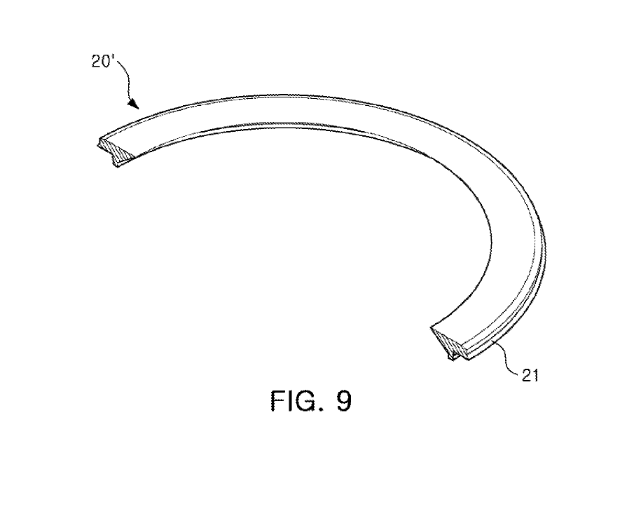

In addition, FIG. 9 is a partially cut-away perspective view of a press-fitting ring provided in the lens module according to another exemplary embodiment of the present disclosure.

Referring to FIGS. 5 through 9, a lens module according to another exemplary embodiment of the present disclosure is the same as the lens module according to an exemplary embodiment of the present disclosure described above except for a coupling structure between a lens barrel 10′ and a press-fitting ring 20′. Therefore, a description for structures other than the coupling structure between the lens barrel 10′ and the press-fitting ring 20′ will be omitted.

In another exemplary embodiment of the present disclosure, an accommodating portion 11′ into which the press-fitting ring 20′ is fitted may be provided in the lens barrel 10′.

The accommodating portion 11′ may be formed in a shape of a hole penetrating through the lens barrel 10′, as shown in FIGS. 5 through 7, or be formed in a shape of a groove in an inner surface of the lens barrel 10″, as shown in FIG. 8.

A plurality of holes or grooves may be disposed to be spaced apart from each other.

The press-fitting ring 20′ may be provided with a protruding part 21 protruding toward the accommodating portion 11′.

For example, the protruding part 21 may protrude from a side surface of the press-fitting ring 20′ toward the accommodating portion 11′.

Here, an outer diameter of a portion of the press-fitting ring 20′ in which the protruding part 21 is not formed may correspond to an inner diameter of the lens barrel 10′, and an outer diameter of a portion of the press-fitting ring 20′ in which the protruding part 21 is formed may be greater than the inner diameter of the lens barrel 10′.

Therefore, when the press-fitting ring 20′ is inserted into the lens barrel 10′ in the direction from the image side toward the object side, the protruding part 21 of the press-fitting ring 20′ may be inserted into the accommodating portion 11′.

For example, the protruding part 21 may be caught by the accommodating portion 11′ while being inserted into the lens barrel 10′. Therefore, the press-fitting ring 20′ may be fixed to the inner portion of the lens barrel 10′.

As set forth above, with the lens module according to exemplary embodiments of the present disclosure, the press-fitting ring supporting the lenses may be stably fixed to the lens barrel.

In addition, the number of manufacturing processes and a manufacturing cost of the lens module may be decreased.

While exemplary embodiments have been shown and described above, it will be apparent to those skilled in the art that modifications and variations could be made without departing from the scope of the present invention as defined by the appended claims.

What is claimed is:

1. A lens module comprising:
a lens barrel accommodating one or more lenses; and
a press-fitting ring accommodated in the lens barrel and supporting the one or more lenses,
wherein the lens barrel has a protrusion portion formed on an inner surface of the lens barrel to support the press-fitting ring.

2. The lens module of claim 1, wherein lens barrel includes a small diameter portion accommodating the one or more lenses and a large diameter portion accommodating the press-fitting ring.

3. The lens module of claim 2, wherein the large diameter portion has a diameter greater than a diameter of the small diameter portion.

4. The lens module of claim 2, wherein the protrusion portion is formed on the large diameter portion.

5. The lens module of claim 1, wherein the protrusion portion protrudes from the inner surface of the lens barrel.

6. The lens module of claim 1, wherein the protrusion portion has an inclined surface.

7. The lens module of claim 1, wherein the protrusion portion is formed to have a form inclined toward a center of the lens barrel in a direction from an image side toward an object side.

8. The lens module of claim 1, wherein the protrusion portion includes a plurality of protrusions disposed to be spaced apart from each other.

9. A lens module comprising:
a lens barrel accommodating one or more lenses; and
a press-fitting ring accommodated in the lens barrel and supporting the one or more lenses,
wherein the lens barrel is provided with an accommodating portion formed therein into which the press-fitting ring is fitted.

10. The lens module of claim 9, wherein the accommodating portion has a shape of a hole penetrating through the lens barrel.

11. The lens module of claim 10, wherein the accommodating portion includes a plurality of holes disposed to be spaced apart from each other.

12. The lens module of claim 9, wherein the accommodating portion has a groove formed in an inner surface of the lens barrel.

13. The lens module of claim 12, wherein the accommodating portion includes a plurality of grooves disposed to be spaced apart from each other.

14. The lens module of claim 9, wherein the press-fitting ring has a protrusion portion protruding therefrom toward the accommodating portion.

15. The lens module of claim 14, wherein the protrusion portion is inserted into and coupled to the accommodating portion.
